(19) United States
(12) Patent Application Publication
(10) Pub. No.: US 2019/0042699 A1
(43) Pub. Date: Feb. 7, 2019

(54) PROCESSING USER MEDICAL COMMUNICATION

(71) Applicant: International Business Machines Corporation, Armonk, NY (US)

(72) Inventors: Paul R. Bastide, Boxford, MA (US); Sunil K. Mishra, Morrisville, NC (US); Anca Sailer, Scarsdale, NY (US); Mattia Tomasoni, Dublin (IE); Benjamin C. Wisnewski, Columbia, MO (US)

(21) Appl. No.: 15/669,016

(22) Filed: Aug. 4, 2017

(51) Int. Cl. G06F 19/00; G06F 17/30

(52) U.S. Cl. CPC G06F 19/3418; G06F 17/3053; G06F 17/30309; G06F 19/3431

(57) ABSTRACT

A method, a computing system and a computer program product are provided. A medical communication is received and a user who originated the medical communication is identified. The medical communication and the medical history of the identified user are analyzed and values of the attributes of the medical communication are determined. A score for the medical communication is generated based on the determined values of the attributes and the medical history. An action is performed with respect to the identified user based on the generated score for the medical communication.

### BACKGROUND

### Field of the Invention

Present invention embodiments are related to systems, methods and computer program products for maximizing initiation of a medical experience. In particular, present invention embodiments receive an electronic communication, identify a user initiating the electronic communication, monitor and analyze attributes of the electronic communication, generate a score based on the analyzed attributes and a medical history, and perform an action based on the generated score.

### Description of Related Art

A first contact that a patient has with a medical provider is typically via an integrated voice response (IVR) system with a scripted electronic interface. Assuming that a patient, Alice, has a cold and Bob works in a doctor's office, a typical scenario may be as follows:
Alice calls the doctor's office.
An IVR system answers by announcing “Welcome to Northeast Doctors.”
The IVR may then walk Alice through an IVR tree.
   If you are experiencing a medical emergency, please hang up and call 9-1-1.
   If you are scheduling an appointment with X, press 1.
   If you are scheduling an appointment with Y, press 2.
   If you hold on the line, an operator will be with you . . . .
Alice presses 2.
. . . <music plays> . . . .
A few minutes pass and Alice becomes frustrated.
Bob answers for Y—“Good day, please hold.”
Exasperated, Alice says “My goodness!”

Reactions to the electronic interface vary. The user may be thankful when the contact is over and may be frustrated when he or she cannot get to the desired person in a timely manner.

### SUMMARY

In a first aspect of the invention, a machine-implemented method of processing a medical communication is provided. A medical communication is received by a computing system. The computing system identifies a user who originated the medical communication. The computing system analyzes the medical communication and a medical history of the identified user and determines values of attributes of the medical communication. A score for the medical communication is generated by the computing system based on the determined values of the attributes and the medical history. The computing system performs an action with respect to the identified user based on the generated score for the medical communication.

In another aspect of the invention, a computing system for processing a medical communication is provided. The computing system includes a network adaptor to receive and send communications via a network, a memory for storing data and instructions, a database system to store medical histories of multiple users, and at least one processor connected with the memory, the network adapter and the database system. The at least one processor is configured to perform a number of steps including: receiving a medical communication; identifying a user originating the medical communication; analyzing the medical communication and a medical history of the identified user and determining values of attributes of the medical communication; generating a score for the medical communication based on the determined values of the attributes and the medical history; and performing an action with respect to the identified user based on the generated score for the medical communication.

In a third aspect of the invention a computer program product is provided. The computer program product includes at least one computer readable storage medium having computer readable program code embodied therewith for execution on at least one processor. The computer readable program code is configured to be executed by the at least one processor to perform: receiving a medical communication; identifying a user originating the medical communication; analyzing the medical communication and a medical history of the identified user and determining values of attributes of the medical communication; generating a score for the medical communication based on the determined values of the attributes and the medical history; and performing an action with respect to the identified user based on the generated score for the medical communication.

### BRIEF DESCRIPTION OF THE DRAWINGS

Generally, like reference numerals in the various figures are utilized to designate like components.

FIG. 1 illustrates a functional block diagram of an example computing system that can be used to implement various embodiments of the invention.

FIG. 2 is a flowchart of an example process for receiving, analyzing and generating a score for a medical communication and performing an action based on the score according to an embodiment of the present invention.

FIG. 3 is a flowchart for identifying a user who originated a medical communication and accessing the user's medical history according to an embodiment of the present invention.

FIG. 4 shows a flowchart of an example process for generating a score for a medical communication according to an embodiment of the present invention.

FIG. 5 shows a flowchart of an example process to determine and perform an action based on a score of a medical communication according to an embodiment of the present invention.

### DETAILED DESCRIPTION

Present invention embodiments include methods, systems and computer program products for maximizing a medical experience for a user. A medical communication may be received from a user. The medical communication may be a phone call or a text message. Embodiments may identify the user who originated the medical communication, may monitor and determine values of attributes of the medical communication, may identify a user who originated the medical communication, may access a medical history of the user, may generate a score based on the determined values of the attributes and the medical history, and may perform an action based on the generated score.

In various embodiments, when the medical communication is a telephone call, the user may be identified via identifying information such as a calling telephone number or other identifying information, which may be received with the telephone call. In embodiments that receive a medical communication via a text message, the user may be identified via identifying information associated with a sending device of the user that originates the text message. The identifying information may be a number associated with the device such as, for example, a telephone number or other identifying information.

An integrated interactive voice response (IVR) system may be included in various embodiments that receive telephone communications. The IVR system may receive and answer a telephone communication and may analyze and monitor determined values of attributes of the received telephone communication. Attributes that may be analyzed and monitored may include, but not be limited to, sentiment, pitch, pauses, cadence and context.

Embodiments that receive text communications may include an integrated interactive text messaging (ITM) system that receives text communications. The text messaging system may receive incoming medical text communications and may analyze and monitor a number of attributes that may include, but not be limited to sentiment and context.

In the embodiments, a medical history of an identified user may be accessed and a classification of the medical history may be determined. In some embodiments, the medical history may be classified as one of: at risk; unhealthy; and healthy. In other embodiments, additional or other risk classifications may be included. A risk factor may be assigned a numerical value corresponding to the classification of the medical history. The risk factor may be used as a weight when generating a score for a medical communication. An action may be performed based on the generated score.

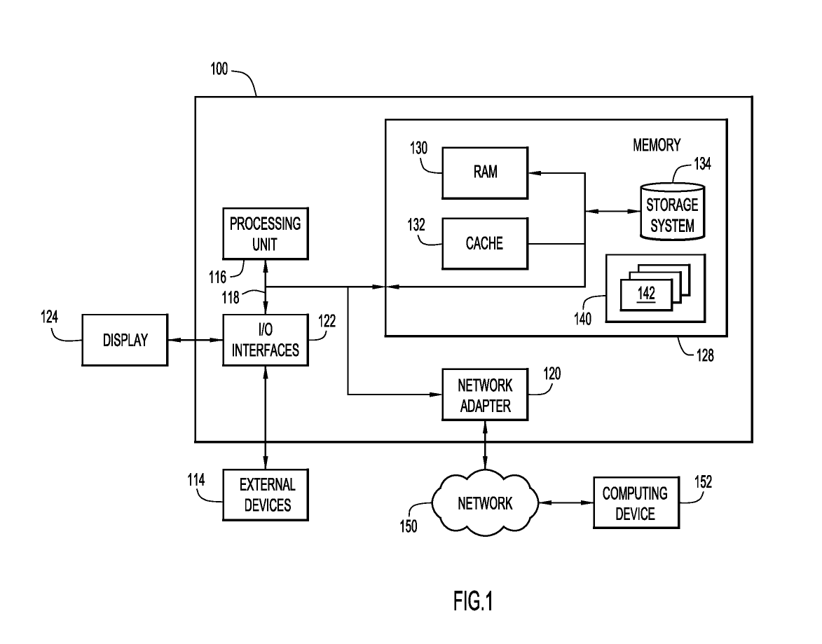

FIG. 1 is a functional block diagram of a computing system 100 that may implement various embodiments of the invention. Computing system 100 is shown in a form of a general-purpose computing device. Components of computing system 100 may include, but are not limited to, one or more processors or processing units 116, a system memory 128, and a bus 118 that couples various system components including system memory 128 to one or more processors 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computing system 100 typically includes a variety of computer system readable media. Such media may be any available media that is accessible by computing system 100, and may include both volatile and non-volatile media, removable and non-removable media.

System memory 128 can include computer system readable media in the form of volatile memory, such as random access memory (RAM) 130 and/or cache memory 132. Computing system 100 may further include other removable/non-removable, volatile/non-volatile computer system storage media. By way of example only, storage system 134 can be provided for reading from and writing to a non-removable, non-volatile magnetic media (not shown and typically called a “hard drive”). In some embodiments, storage system 134 may include a database system. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. As will be further depicted and described below, memory 128 may include at least one program product having a set (e.g., at least one) of program modules that are configured to carry out the functions of embodiments of the invention.

Program/utility 140, having a set (at least one) of program modules 142, may be stored in memory 128 by way of example, and not limitation, as well as an operating system, one or more application programs, other program modules, and program data. Each of the operating system, the one or more application programs, the other program modules, and the program data or some combination thereof, may include an implementation of a networking environment. Program modules 142 generally carry out the functions and/or methodologies of embodiments of the invention as described herein. In some embodiments, program modules 142 may include one or more modules for implementing functions of an integrated IVR system and/or an integrated interactive text messaging system.

Computing system 100 may also communicate with one or more external devices 114 such as a keyboard, a pointing device, a display 124, etc.; one or more devices that enable a user to interact with computing system 100; and/or any devices (e.g., network card, modem, etc.) that enable computing system 100 to communicate with one or more other computing devices. Such communication can occur via Input/Output (I/O) interfaces 122. Still yet, computing system 100 may communicate with one or more networks such as a local area network (LAN), a general wide area network (WAN), and/or a public network (e.g., the Internet) via network adapter 120. As depicted, network adapter 120 communicates with the other components of computing system 100 via bus 118. It should be understood that, although not shown, other hardware and/or software components could be used in conjunction with computing system 100. Examples, include, but are not limited to: microcode, device drivers, redundant processing units, external disk drive arrays, RAID systems, tape drives, and data archival storage systems, etc.

In some embodiments, computing system 100 may communicate with a user, who originated a medical communication, via network adapter 120, network 150 and computing device 152. Network 150 may include a packet switched network, a public switched telecommunications network (PSTN), wired and wireless networks, the Internet, or other types of networks. Computing device 152 may include a tablet computer, a mobile phone (including a smartphone), a desktop or laptop computer, or other type of computing device.

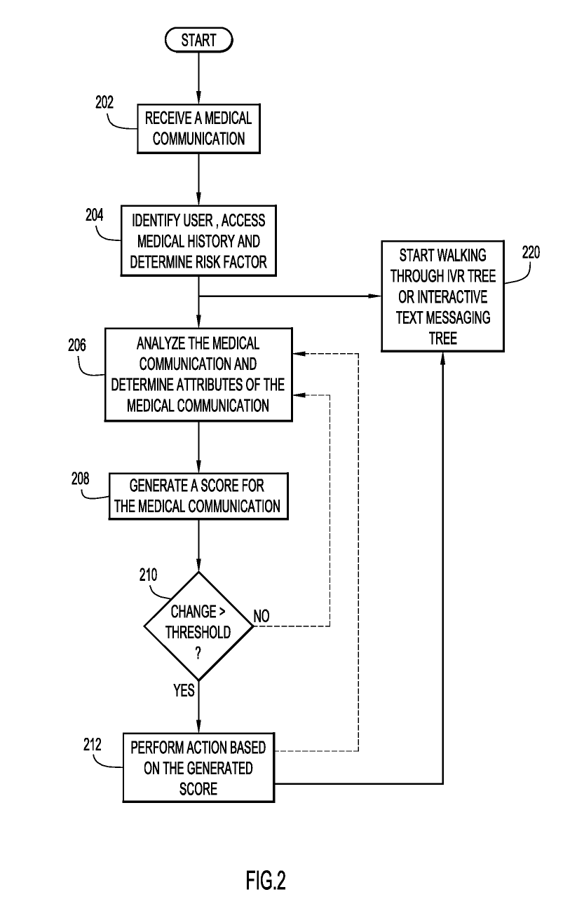

FIG. 2 is a flowchart of a process that may be performed in various embodiments. The process may begin with computing system 100 receiving a medical communication, which may be a telephone communication or a text messaging communication (act 202). In some embodiments, the telephone communication may be received by computing system 100 via a Voice over IP protocol (VoIP) over a packet switching network. In other embodiments, the telephone communication may be received by computing system 100 via a public switched telephone network (PSTN). In further embodiments, computing system 100 may receive text messaging communications via a short messaging service (SMS) over a wired or wireless network or may receive text messaging communications via an online communication facility for receiving and sending text messages instantaneously. The medical communication may be a call concerning lab test results, scheduling an appointment with a particular physician or nurse practitioner, or for any other reason a patient may contact a doctor's office.

Computing system 100 may then identify a calling user and may access a corresponding medical history (act 204). The user may be identified based on received identifying information such as, for example, a calling telephone number with respect to an embodiment that receives telephone communications. In embodiments that receive text communications, identifying information associated with a device that originated the text communication such as, for example, a number of a mobile phone or other identifying information, may be used to identify a user who originated a received text communication. In embodiments in which the identifying information includes, for example, a telephone number, computing system 100 may check any of an Enterprise Master Patient Index, a directory of phone numbers, a social network, etc. to attempt to identify a user.

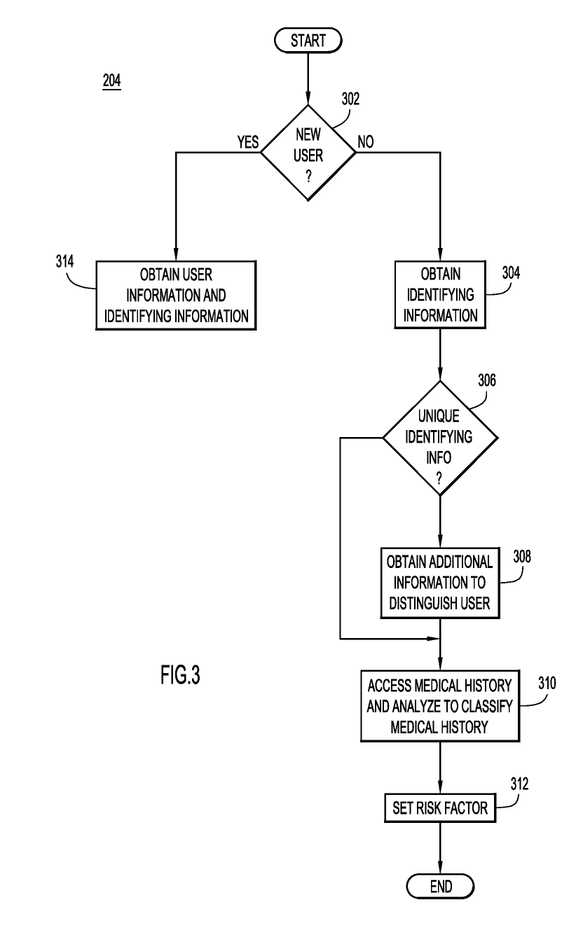

FIG. 3 is a flowchart illustrating in more detail example processing of act 204 in some embodiments. The process may begin by determining whether the user is a new user (act 302). Whether the user is a new user may be determined by prompting the user to indicate whether he or she is a new user or via other methods. If the user is determined not to be a new user, then computing system 100 may obtain identifying information (act 304). The identifying information may include, but not be limited to, caller ID information regarding a telephone call or a unique identifier of an originating device. Computing system 100 may then determine whether the identifying information is already associated with at least one other user (act 306). If the identifying information is associated with at least one other user, then computing system 100 may prompt the user to provide additional information, which may include, but not be limited to, a date of birth, a favorite color, a name of a best friend, etc., in order to distinguish the user who originated the medical communication from the at least one other user associated with the identifying information (act 308).

Once the user is identified, computing system 100 may access and analyze a medical history of the identified user (act 310), which may be obtained from, for example, a database of a medical provider or other database with permission from the identified user. In some embodiments, results of the analysis of the medical history may produce a classification of the medical history as indicating one of a healthy individual, an unhealthy individual and an at risk individual. The analysis of the medical history may include analyzing terms used in the medical history that indicate a seriousness of a medical condition. If the user is new and an associated medical history is not yet stored, then in some embodiments, the classification of the associated medical history may be set to a default classification, which may be an indication of a healthy individual. In other embodiments, a different default classification may be used.

Computing system 100 may then set a value of a risk factor based on the classification of the medical history (act 312). In some embodiments: the risk factor may be set to a value of 1 if the analysis of the medical history indicates the healthy individual; the risk factor may be set to a value of 10 if the analysis of the medical history indicates the unhealthy individual; and the risk factor may be set to a value of 100 if the analysis of the medical history indicates the at risk individual.

In other embodiments, additional or other classifications of the medical history may be employed in addition to other values of associated risk factors.

Returning to FIG. 2, computing system 100 may start walking the user through an interactive voice response tree or an interactive text messaging tree (act 220). This may occur while computing system 100 is performing act 204 or, in some embodiments, may occur after act 204 is performed.

Next, computing system 100 may analyze the received medical communication and determine associated values of attributes (act 206). The attributes may include, but not be limited to sentiment and context. If the medical communication is via a telephone call, the attributes may further include pitch, pauses and cadence. The sentiment attribute may have an integer value in a range such as, for example, from −5 to 5. The pitch attribute may have a value selected, for example, from a group of low, medium and high in which: low may be represented by a value of 10; medium may be represented by a value of 20; and high may be represented by a value of 30. The pauses attribute may have an integer value indicating a number of pauses (for a voice communication). The cadence attribute may indicate a beat, a rate, or a measure of any rhythmic movement regarding a sequence of words and may have a value selected from one of 10 representing slow, 20 representing medium and 30 representing fast (for a voice communication). The context attribute may have one of a number of values based on the context, each of which may represent a context such as, for example, “waiting—listening to music”, “waiting—playing a game”, “connecting to a patient advocate”, “waiting with a patient advocate”, etc. In some embodiments, the attributes may be monitored continuously during a duration of the medical communication.

While the attributes of the medical communication continue to be monitored (as indicated by the dashed arrows), every predetermined time interval, computing system 100 may generate a score for the medical communication based on current values of the monitored attributes and the medical history (act 208). The predetermined time interval may be 30 seconds, 1 minute, 5 minutes, or some other suitable time interval.

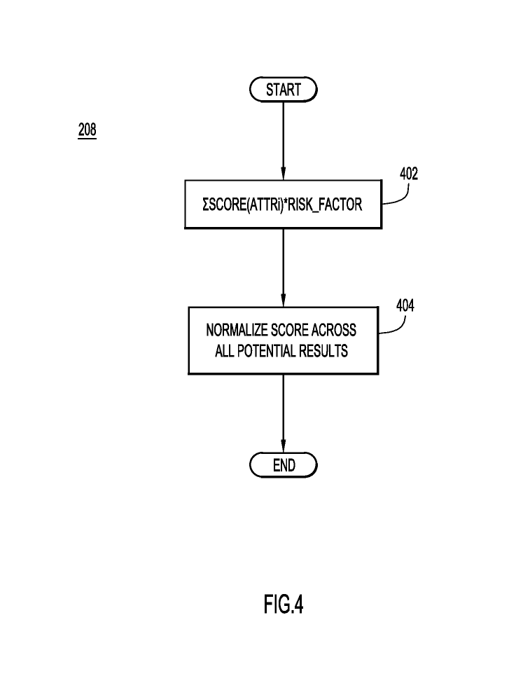

FIG. 4 is a flowchart of an example process for generating the score during act 208. The process may begin by summing the value of each attribute of the medical communication and multiplying the sum by a value of the risk factor to produce a product (act 402). The resulting product may be normalized across all potential results to generate the score in a range such that 0≤score≤100 (act 404).

In embodiments that receive text messages, the attributes of the medical communication may be monitored and determined for each text message received for a same identified user over a predetermined time interval such as, for example, 15 minutes or another time interval, or until at least a predetermined time period passes during which no medical communication is received from the user.

The flowchart of FIG. 4 illustrates one example method of generating a score. Other methods of generating a score may be employed in other embodiments. For example, in another embodiment, the generated score may be produced by performing act 402 and then dividing a result of act 402 by an average score of the identified user. Numerous other methods may be used to generate a score in other embodiments.

Returning to FIG. 2, during act 210, the generated score may be compared with a last previously generated score for a medical communication from the user, or an average of the generated scores during a duration of the medical communication to determine a percentage change of the generated score with respect to the value to which the generated score is compared. If, during act 210, a percentage change in the generated score is determined to exceed a threshold, as a result of the comparison, act 212 may be performed by computing system 100 to notify a process performing act 220 to perform an action based on the generated score. The threshold may be 15%, 25%, or another suitable percentage. In some embodiments, after initially generating a score for a medical communication, the score may be compared with an average generated score for the user. The average may be determined based on an average score for the user with respect to one or more previous medical communications from the user. If no previous medical communications exist, the initial generated score may be initially compared with a predetermined value such as for example, 50 or some other value in an embodiment in which the generated score may be in a range of 1 to 100.

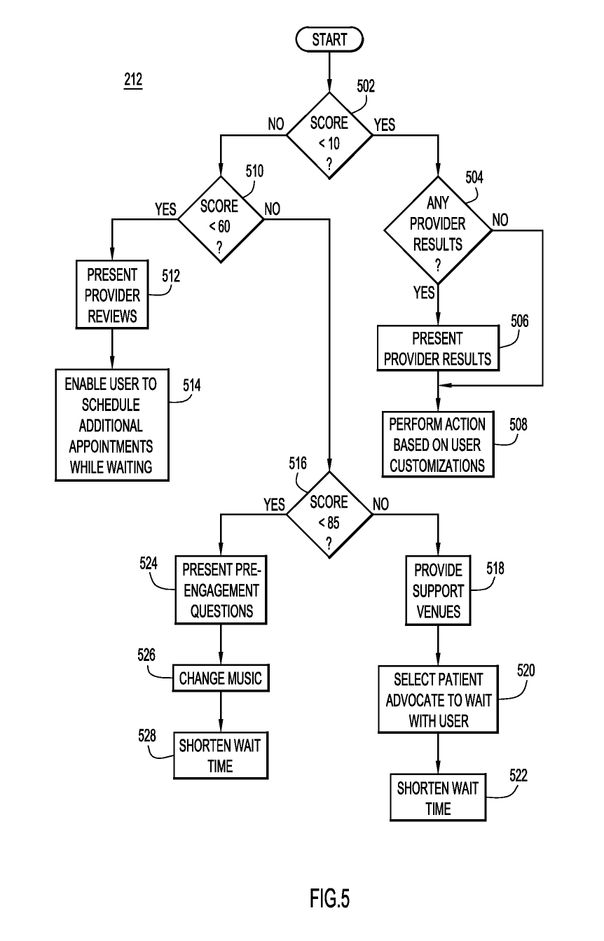

FIG. 5 is a flowchart of an example process that may be performed in some embodiments during act 212. The process may begin by determining whether the generated score is less than 10 (act 502). If the generated score is less than 10, then computing system 100 may determine whether there are any provider results to present to the user based on interactions with the user (act 504). The provider results may include a success rate the provider has with treating a medical condition of the user. If there are provider results to present, computing system 100 may present the results in a response to the user (act 506). After providing the provider results, in act 506, or after determining that there are no provider results, in act 504, then computing system 100 may perform an action based on user customizations (act 508). The user customizations may be based on preferences stored in a user profile, may be based on previous actions taken by the user, or may be based on preferences expressed by the user in response to prompts from computing system 100. For example, if the user previously played a game while waiting for a response to a medical communication, the user may be offered a game to play. Similarly, if the user previously indicated an interest in a specific topic, the user may be provided with an option to receive information regarding the topic while waiting for a response to a medical communication. Numerous other actions may be performed based on previous actions of the user or preferences stored in a user profile.

If, during act 502, the score is determined not to be less than 10, then computing system 100 may determine whether the score is less than 60 (act 510). If the score is determined to be less than 60 during act 510, then computing system 100 may provide, to the user, reviews of medical providers in a practice (act 512). Computing system 100 may then enable the user to schedule additional appointments while waiting for a response to the medical communication (act 514).

If, during act 510, computing system 100 determines that the score is not less than 60, then computing system 100 may determine whether the score is less than 85 (act 516). If, during act 516, the score is determined not to be less than 85, then computing system 100 may provide information regarding support venues (act 518). The support venues may include real stories regarding treatment for various conditions such as, for example, conditions which the user may be suffering from, based on the associated medical history. The support venues may also include, but not be limited to, information regarding free support groups, pro bono health services, and support group advertisements. Computing system 100 may also select a patient advocate to wait with the user (act 520) and may take actions to shorten a wait time for the user (act 522). The actions to shorten the wait time for the user may include, but not be limited to, notifying a called party regarding the user waiting, and obtaining information from the user for better directing the medical communication to a proper destination.

If, during act 516, computing system 100 determines that the score is less than 85, then computing system 100 may present pre-engagement questions to the user (act 524), may change music that is being provided to the user (act 526), and may take actions to shorten a wait time for the user (act 528).

The processing shown by the flowchart of FIG. 5 is only one example of actions that may be performed based on a generated score for the medical communication. In other embodiments, other actions may be performed based on other ranges of generated scores.

In some embodiments, a single model may be used to evaluate attributes of medical communications from users to determine corresponding attribute values. The model may be predefined or may be trained using natural language processing and machine learning techniques based on using data from a number of medical communications from multiple users.

In other embodiments, a model may be trained for each user based on using data from previous medical communications from the user. In such embodiments, a relatively huge amount of storage would be required to store the models for each of the users. However, more accurate values may be determined for each of the attributes of medical communications from each of the individual users.

The environment of present invention embodiments may include any number of computers or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, voice recognition, etc.) to enter and/or view information.

It is to be understood that the software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and may communicate via any suitable communications medium (e.g., LAN, WAN, Intranet, Internet, hardwired, modem connection, wireless, etc.). For example, the functions of the present invention embodiments may be distributed in any manner among the various systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to a server and/or client systems. The database systems and/or storage structures may be remote from or local to the computer or other processing systems, and may store any desired data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A machine-implemented method of processing a medical communication comprising:
receiving, at a computing system, a medical communication;
identifying, by the computing system, a user originating the medical communication;
analyzing, by the computing system, the medical communication and a medical history of the identified user, and determining values of attributes of the medical communication;
generating, by the computing system, a score for the medical communication based on the determined values of the attributes and the medical history; and
performing, by the computing system, an action with respect to the identified user based on the generated score for the medical communication.

2. The machine-implemented method of claim 1, wherein the attributes include at least one from a group consisting of sentiment, pitch, pauses, cadence and context.

3. The machine-implemented method of claim 1, wherein the medical communication includes at least one from a group consisting of a voice communication and a text communication.

4. The machine-implemented method of claim 1, wherein the action includes at least one of:
present inquiries to the identified user to obtain information;
present medical provider results related to at least one medical condition;
present medical provider reviews;
provide information regarding venues for the identified user to obtain support;
enable the identified user to schedule at least one medical appointment;
enable communication between the user and a patient advocate;
enable participation in a game;
reduce a wait time for a response;
alter a presentation of music; and
perform an action customized to the identified user.

5. The machine-implemented method of claim 1, wherein the computing system includes at least one of an interactive voice response system and a textual communication system.

6. The machine-implemented method of claim 1, wherein the generating a score further comprises:
dividing a sum of values of the attributes of the medical communication by a value based on a plurality of previously generated scores for other medical communications from the identified user to produce the generated score.

7. The machine-implemented method of claim 1, further comprising:
interacting with the identified user to process the medical communication; and
learning preferences of the identified user for future medical communications based on the interacting.

8. A computing system for processing a medical communication, the communication system comprising:
a network adaptor to receive and send communications;
a memory for storing data and instructions;
a database system to store medical histories of a plurality of users; and
at least one processor connected with the memory, the network adapter and the database system, the at least one processor being configured to:
receive a medical communication;
identify a user originating the medical communication;
analyze the medical communication and a medical history of the identified user, and determine values of attributes of the medical communication;
generate a score for the medical communication based on the determined values of the attributes and the medical history; and
perform an action with respect to the identified user based on the generated score for the medical communication.

9. The computing system of claim 8, wherein the attributes include at least one from a group consisting of sentiment, pitch, pauses, cadence and context.

10. The computing system of claim 8, wherein the medical communication includes at least one from a group consisting of a voice communication and a text communication.

11. The computing system of claim 8, wherein the action includes at least one of:
present inquiries to the identified user to obtain information;
present medical provider results related to at least one medical condition;
present medical provider reviews;
provide information regarding venues for the identified user to obtain support;
enable the identified user to schedule at least one medical appointment;
enable communication between the user and a patient advocate;
enable participation in a game;
reduce a wait time for a response;
alter a presentation of music; and
perform an action customized to the identified user.

12. The communication system of claim 8, wherein the computing system includes one of an interactive voice response system and a textual communication system.

13. The communication system of claim 8, wherein the generating a score further comprises:
dividing a sum of values of the attributes of the medical communication by a value based on a plurality of previously generated scores for other medical communications from the identified user to produce the generated score.

14. The computing system of claim 8, wherein the at least one processor is further configured to:
interact with the identified user to process the medical communication; and
learn preferences of the identified user for future medical communications based on the interacting.

15. A computer program product comprising:
at least one computer readable storage medium having computer readable program code embodied therewith for execution on at least one processor, the computer readable program code being configured to be executed by the at least one processor to perform:
receiving a medical communication;
identifying a user originating the medical communication;
analyzing the medical communication and a medical history of the identified user, and determining values of attributes of the medical communication;
generating a score for the medical communication based on the determined values of the attributes and the medical history; and
performing an action with respect to the identified user based on the generated score for the medical communication.

16. The computer program product of claim 15, wherein the attributes include at least one from a group consisting of sentiment, pitch, pauses, cadence and context.

17. The computer program product of claim 15, wherein the medical communication includes at least one from a group consisting of a voice communication and a text communication.

18. The computer program product of claim 15, wherein the action includes at least one of:
present inquiries to the identified user to obtain information;
present medical provider results related to at least one medical condition;
present medical provider reviews;
provide information regarding venues for the identified user to obtain support;
enable the identified user to schedule at least one medical appointment;
enable communication between the user and a patient advocate;
enable participation in a game;
reduce a wait time for a response;
alter a presentation of music; and
perform an action customized to the identified user.

19. The computer program product of claim 15, wherein the generating a score further comprises:
dividing a sum of values of the attributes of the medical communication by a value based on a plurality of previously generated scores for other medical communications from the identified user to produce the generated score.

20. The computer program product of claim 15, wherein the computer readable program code is further configured to be executed by the at least one processor to perform:
interacting with the identified user to process the medical communication; and
learning preferences of the identified user for future medical communications based on the interacting.
